(19) United States
(12) Patent Application Publication
(10) Pub. No.: US 2011/0307400 A1
(43) Pub. Date: Dec. 15, 2011

(54) Information and Communication Systems and Platforms and Their Methods of Use

(76) Inventor: Arthur R. Chang, El Monte, CA (US)

(21) Appl. No.: 13/159,834

(22) Filed: Jun. 14, 2011

Related U.S. Application Data
(60) Provisional application No. 61/354,369, filed on Jun. 14, 2010.
(60) Provisional application No. 61/459,379, filed on Dec. 13, 2010.

(51) Int. Cl. G06Q 99/00; G06F 15/16

(52) U.S. Cl. 705/319; 709/204

(57) ABSTRACT

Information and communication system are disclosed that include at least one virtual map comprising at least one contact, at least one search box that is related to the at least one virtual map, and at least one two-way interactive communication function. In some embodiments, the at least one virtual map comprises a trade show booth layout, a job fair, a street map, a city map, a building layout, a mall layout or a combination thereof. Methods of using a two-way communication and information system comprises: providing at least one prospective customer, customer, entity contact or a combination thereof, providing at least one vendor contact, providing at least one virtual map comprising the at least one vendor contact, providing at least one search box that searchably relates the at least one vendor contact to the at least one virtual map, utilizing the search box to locate a vendor contact of interest, and utilizing at least one two-way interactive communication function to interactively connect the at least one vendor contact with the at least one prospective customer, customer, entity contact or a combination thereof in real-time.

This application claims priority to U.S. Provisional Application Ser. No. 61/354369 filed on Jun. 14, 2010 and U.S. Provisional Application Ser. No. 61/459379 filed on Dec. 13, 2010, both of which are incorporated by reference herein in their entirety.

### FIELD OF THE SUBJECT MATTER

The field of the subject matter is information and communications systems, software and platforms, along with their methods of use.

### BACKGROUND

Trade shows, consumer product shows, conventions and expositions usually have a product and services show as part of the event that is designed to introduce attendees to new products, get contact information of attendees and ultimately sell products and services to the attendees.

The simplest way to introduce the attendee or consumer to the products and services is to hand the attendee/consumer a map of the booths on the product show floor, along with a list of the vendors and related booth numbers. The attendee/consumer is left to review the list, find the booth on the map and then walk to the booth to determine if the product or service is the desirable. The vendors can then scan a copy of the attendees badge or take a business card in order to contact the attendee after the show with product specials, catalogs or to follow up on sales opportunities.

In recent years, companies have developed systems that are designed to bring vendors together with consumers in a more effective way. For example, attendees can visit websites prior to the show, select vendors they are interested in and put together an “attendance map” that will lead them around to specific booths where they are interested in reviewing the products and services. Other companies, such as Map Your Show or MYS, allow you to view a partially interactive map of the show floor showing all of the vendors. On their exposition or product show maps, an attendee or potential consumer can click on a booth on the virtual map, review product and contact information for the vendor and watch a company or product video. While this product, and similar products, elevate the attendee experience and allows non-attendees to view products without attending the show, there is still some aspects of the consumer experience that are missing.

Another company—Software Management, Inc.—owns at least one patent (U.S. Pat. No. 7,590,688) that is directed to organizing and implementing a virtual convention. The virtual “attendees” can select companies and booths that they want to get information from and the “virtual convention” collects the information, organizes that information and forwards it to the attendee.

To this end, it would be desirable to produce an information and communication system, software package and platform that: a) allows attendees to communicate directly with vendors without being on the show floor in person or even in the same city, state or country, b) allows non-attendees to access the floor map and communicate directly with vendors remotely, c) allows for a two-way real-time and interactive communication experience between the vendors and potential consumers, d) allows for pre-show, show and post-show interactive communication experiences between the vendors and potential consumers, and e) allows the attendees and non-attendees to easily search for products, vendors, geographical information, etc. It is also desirable that this model or platform be translatable into other formats, such as searching for vendors, restaurants or events in neighborhoods, cities, states, or other designated areas, such as malls.

### SUMMARY OF THE SUBJECT MATTER

Information and communication systems are disclosed that include at least one virtual map comprising at least one contact, at least one search box that is related to the at least one virtual map, and at least one two-way interactive communication function.

Information and communication systems are disclosed for a trade show, convention or another type of meeting that includes at least one virtual map comprising at least one contact, at least one search box that is related to the at least one virtual map, and at least one two-way interactive communication function.

Information and communication systems are disclosed for a trade show, convention or another type of meeting that includes storing at least one virtual map on at least one central server, cloud system, intranet system, internet system or a combination thereof comprising at least one contact, at least one interactive search box that is related to the at least one virtual map, and at least one two-way interactive communication function that interacts with at least one user and the at least one central server, cloud system, intranet system, internet system or a combination thereof.

Methods of using a two-way communication and information system comprises: providing at least one prospective customer, customer, entity contact or a combination thereof, providing at least one vendor contact, providing at least one virtual map comprising the at least one vendor contact, providing at least one search box that searchably relates the at least one vendor contact to the at least one virtual map, utilizing the search box to locate a vendor contact of interest, and utilizing at least one two-way interactive communication function to interactively connect the at least one vendor contact with the at least one prospective customer, customer, entity contact or a combination thereof in real-time.

In some embodiments, the at least one virtual map comprises a trade show booth layout, a job fair, a street map, a city map, a building layout, a mall layout or a combination thereof.

### BRIEF DESCRIPTION OF THE FIGURES

FIG. 1 shows a contemplated trade show floor map comprising a “Company or Category” locate search box.

FIG. 2 shows a contemplated trade show floor map comprising a “Company or Category” locate search box where the category “LCD” or “liquid crystal display” is entered in the search box.

FIG. 3 shows a contemplated trade show floor map comprising a “Company or Category” locate search box where the category “LCD” or “liquid crystal display” has been searched and the locations are highlighted.

FIG. 4 shows a contemplated trade show floor map comprising a “Company or Category” locate search box where the company “LG” is entered in the search box.

FIG. 5 shows a contemplated trade show floor map comprising a “Company or Category” locate search box where company “LG” has been searched and the location is highlighted.

FIG. 6 shows a contemplated trade show floor map where the company “LG” has been searched and highlighted. In this embodiment, the user is viewing a product video for LG and/or communicating directly and remotely with someone at LG or in the LG booth.

FIG. 7 shows a contemplated road map comprising a locate search box.

FIG. 8 shows a contemplated road map comprising a locate search box where company “99 Ranch Market” has been entered in the locate search box.

FIG. 9 shows a contemplated road map comprising a locate search box where company “99 Ranch Market” has been searched and the location is highlighted.

FIG. 10 shows a contemplated road map where the company “99 Ranch Market” has been searched and highlighted. In this embodiment, the user is viewing a product video for 99 Ranch Market and/or communicating directly and remotely with someone at the market to get additional information.

FIG. 11 shows a contemplated trade show floor map where the company “LG” has been searched and highlighted. In this embodiment, the user is communicating directly and remotely with someone at LG or in the LG booth using Wave text messaging.

FIG. 12 shows a contemplated trade show floor map where the company “LG” has been searched and highlighted. In this embodiment, the user is communicating directly and remotely with someone at LG or in the LG booth using video communication methods, such as Skype.

FIG. 13 shows a contemplated trade show floor map where the company “LG” has been searched and highlighted. In this embodiment, the user is communicating directly and remotely with someone at LG or in the LG booth using instant messaging.

FIG. 14 shows a contemplated trade show floor map where the company “LG” has been searched and highlighted. In this embodiment, the user is using the call back function which allows the user to provide a call back phone number or E-mail address where someone at the company or in the booth can contact the user when available.

### DETAILED DESCRIPTION

An information and communication system, software package and platform has been developed and is disclosed herein that: a) allows attendees to communicate directly with vendors without being on the show floor in person, b) allows non-attendees to access the floor map and communicate directly with vendors remotely, c) allows for a two-way interactive communication experience between the vendors and potential consumers, d) allows for pre-show, show and post-show interactive communication experiences between the vendors and potential consumers, and e) allows the attendees and non-attendees to easily search for products, vendors, geographical information, etc. Contemplated models and platforms are also translatable into other formats, such as searching for vendors, restaurants or events in neighborhoods, cities, states, or other designated areas, such as malls.

Specifically, information and communication system are disclosed that include at least one virtual map comprising at least one contact, at least one search box that is related to the at least one virtual map, and at least one two-way interactive communication function. In some embodiments, the at least one virtual map comprises a trade show booth layout, a job fair, a street map, a city map, a building layout, a mall layout or a combination thereof.

Methods of using a two-way communication and information system comprises: providing at least one prospective customer, customer, entity contact or a combination thereof, providing at least one vendor contact, providing at least one virtual map comprising the at least one vendor contact, providing at least one search box that searchably relates the at least one vendor contact to the at least one virtual map, utilizing the search box to locate a vendor contact of interest, and utilizing at least one two-way interactive communication function to interactively connect the at least one vendor contact with the at least one prospective customer, customer, entity contact or a combination thereof in real-time, whether it is before, during or after the show or event.

Any suitable business, contact or vendor can utilize this system, including stores, professional services businesses, manufacturing companies, potential employers or employees, or any combination thereof, including vendor contacts. It is contemplated that these systems will work well with most businesses, because it gives any consumer anywhere in the world the opportunity to communication remotely, and in some instances visually, with any business in the world. These contemplated businesses are considered the at least one contact within the context of this disclosure. Contemplated at least one contact comprises a vendor, a store, a professional services business, a manufacturing company, a potential employer or a combination thereof.

Contemplated two-way interactive communication functions communicatively link the at least one user with the at least one contact. The at least one two-way interactive communication function communicatively links at least one user with the at least one contact on the at least one virtual map. A contemplated communicative link may comprise any suitable method or system of linking at least one user with at least one contact communicatively, including an internet network, an intranet network, a cloud network, a wireless network or a combination thereof. For all of contemplated types and forms of communication, it is contemplated that foreign languages and disability issues will be resolved by the system by providing translation services, third-party agents, closed captioning or other suitable services that allow communication to be understood by everyone in the communication loop.

Contemplated methods include at least one search box that searchably relates the at least one vendor contact to the at least one virtual map. The at least one search box is a receptacle for contact identifier information. A potential customer, customer or entity contact utilizes the search box to locate a vendor contact of interest. Once the vendor contact of interest is located, the potential customer, customer or entity contact can initiate contact with the vendor contact in real time to discuss products or services. Contemplated contact identifier information comprises company name, company product category, company services category, contact name, contact electronic mail address or a combination thereof.

Contemplated information and communication systems comprise at least one two-way interactive communication function, wherein the at least one two-way interactive communication function comprises wave messaging, text messaging, instant messaging or video communication functions.

As shown below in the Examples Section and related figures, the trade show floor map shows a plurality of booths that can be selected by the user. The physical booths are equipped with wave, video chat, instant messaging and E-mail, callback to phone functionality or a combination thereof. Wave is a form of communication that includes E-mails and threaded conversations, along with instant messaging, that allows users and booth employees to communicate in real-time when they are both online or in interactive mode. In contemplated embodiments, the at least one virtual map is available to a user before, during or after an event.

Information and communication systems are disclosed for a trade show, convention or another type of meeting that includes at least one virtual map comprising at least one contact, at least one search box that is related to the at least one virtual map, and at least one two-way interactive communication function.

Information and communication systems are disclosed for a trade show, convention or another type of meeting that includes storing at least one virtual map on at least one central server, cloud system, intranet system, internet system or a combination thereof comprising at least one contact, at least one interactive search box that is related to the at least one virtual map, and at least one two-way interactive communication function that interacts with at least one user and the at least one central server, cloud system, intranet system, internet system or a combination thereof.

### EXAMPLES

### Example 1

### Trade Show Exhibition Floor

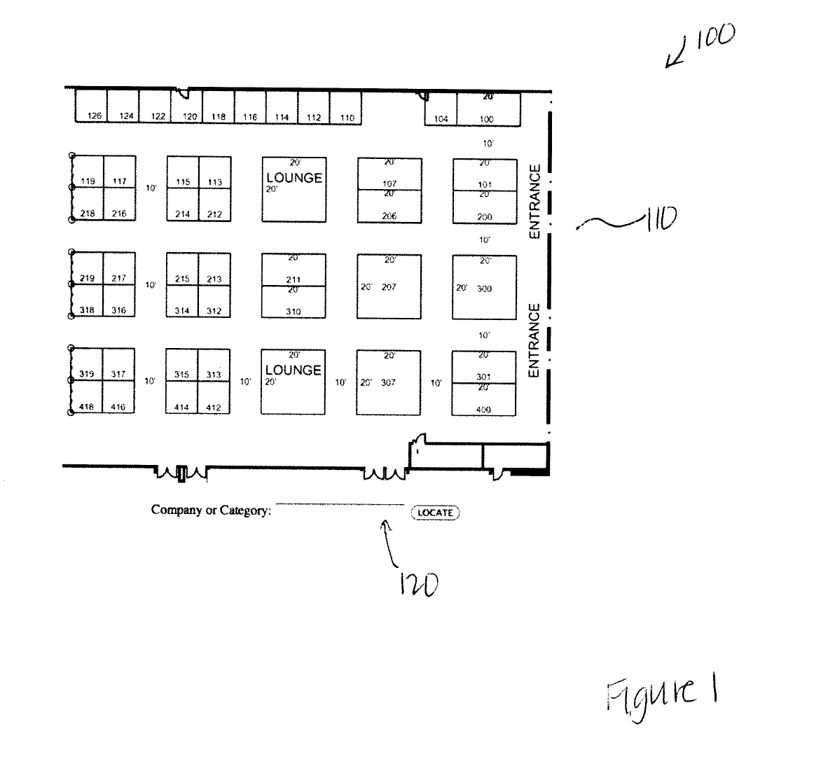

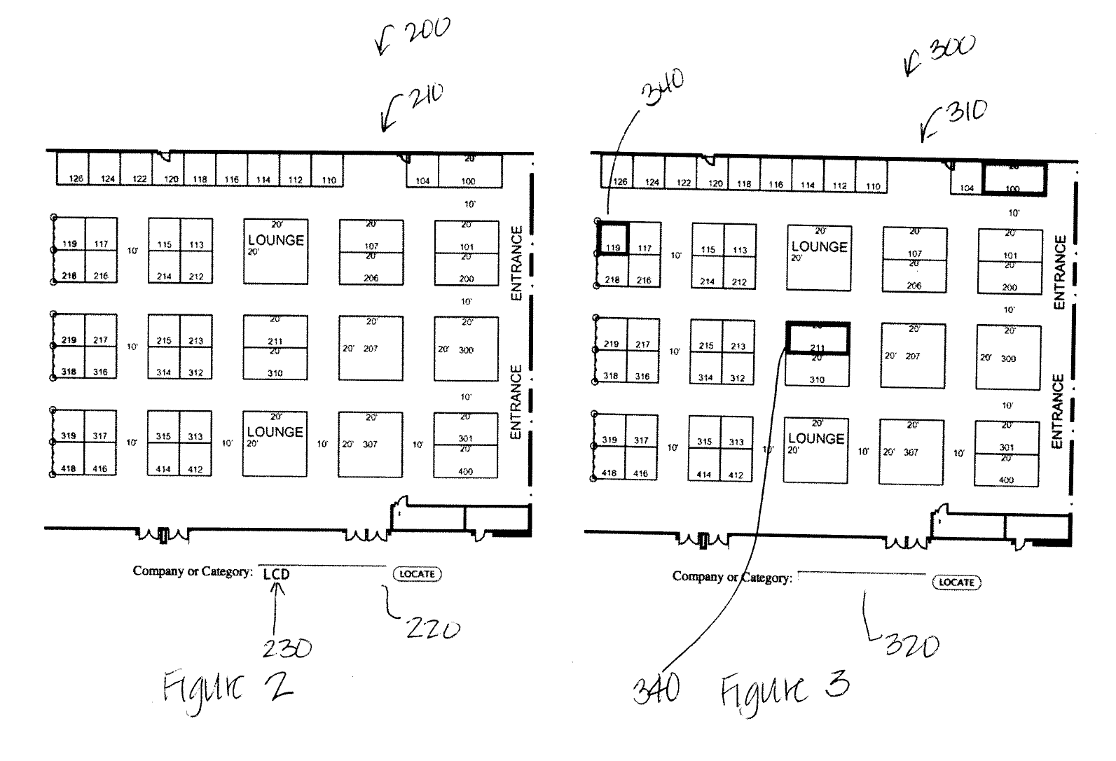

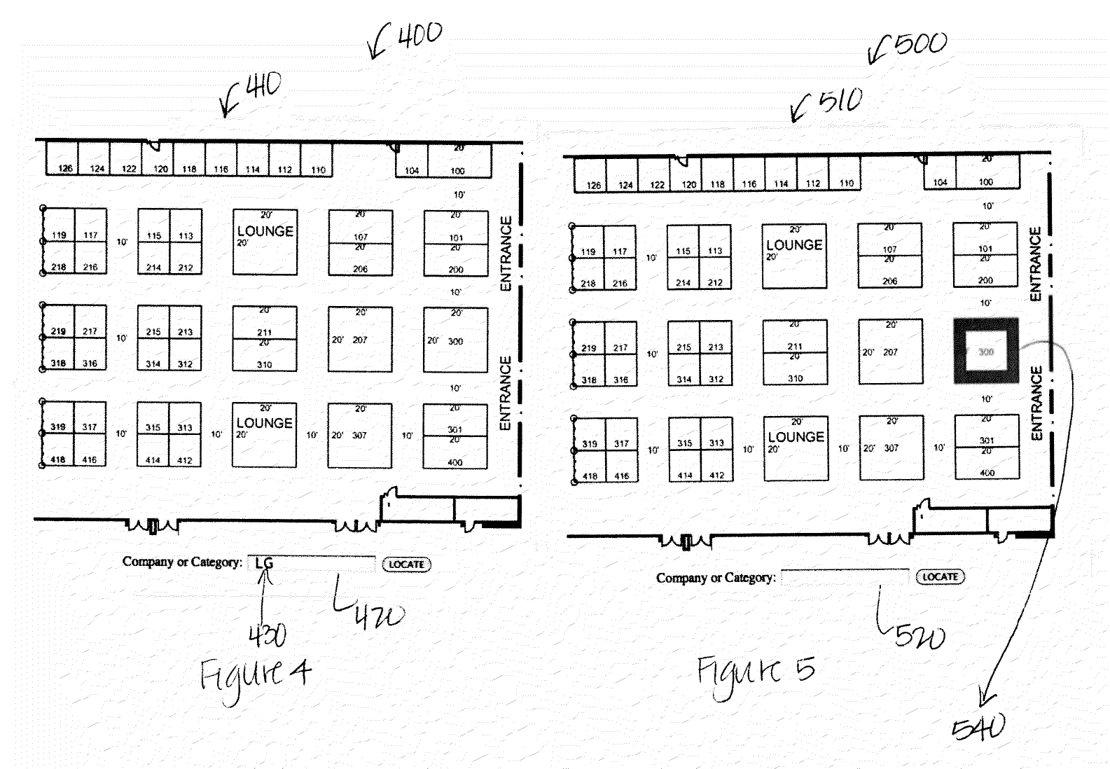

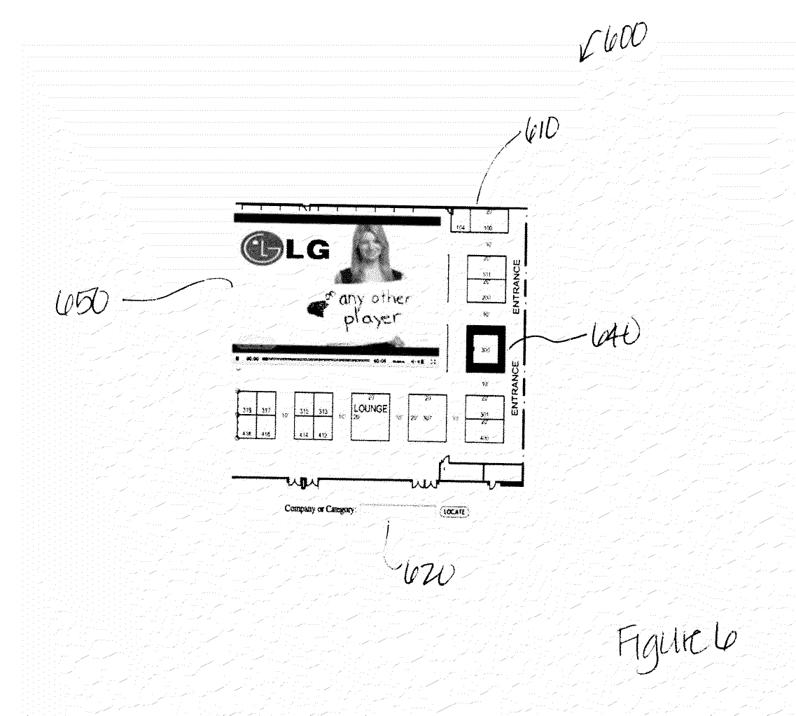

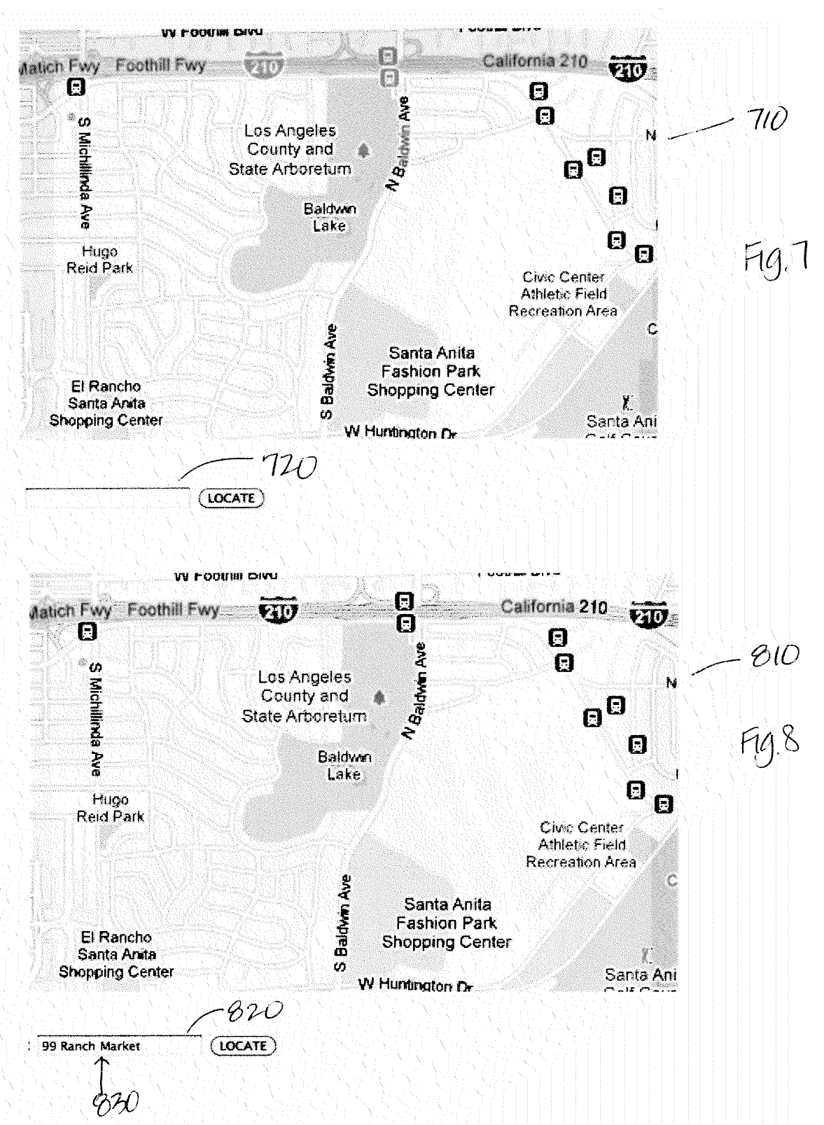

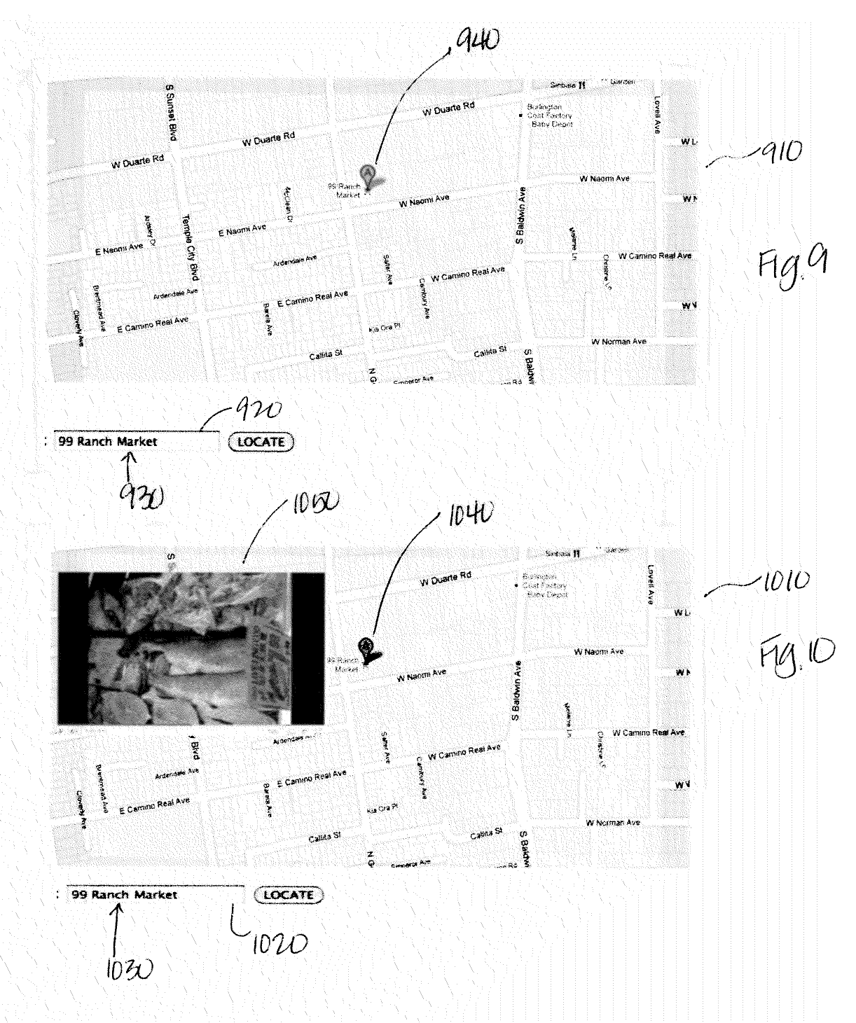

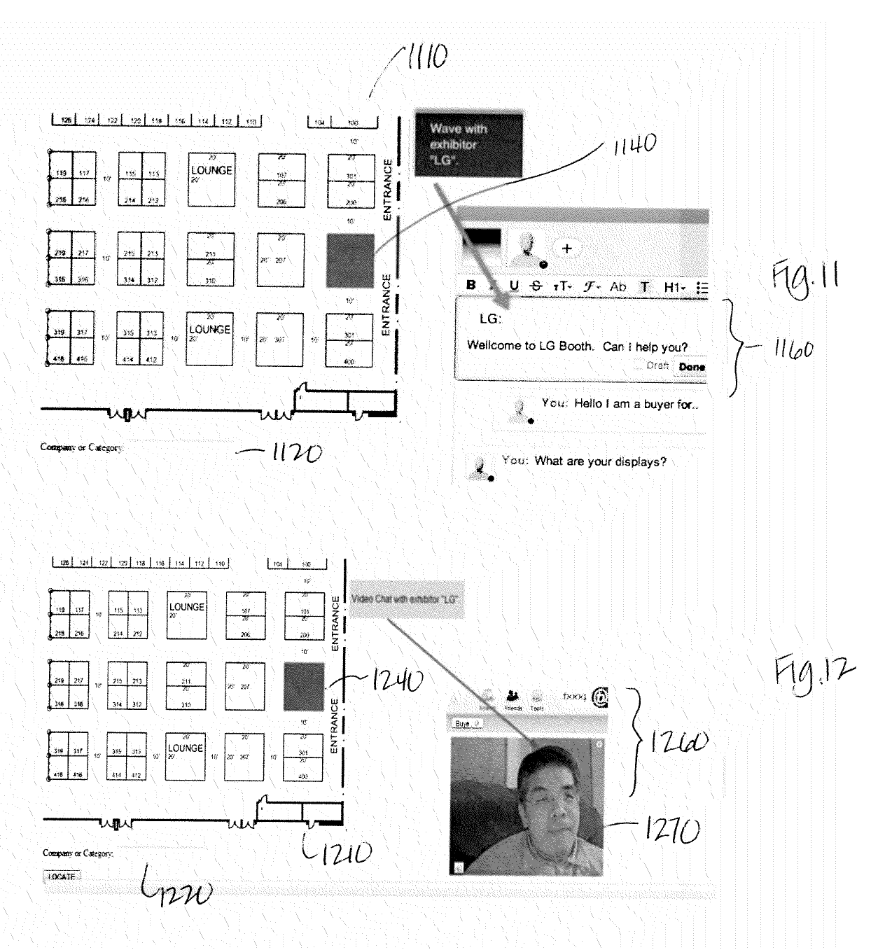

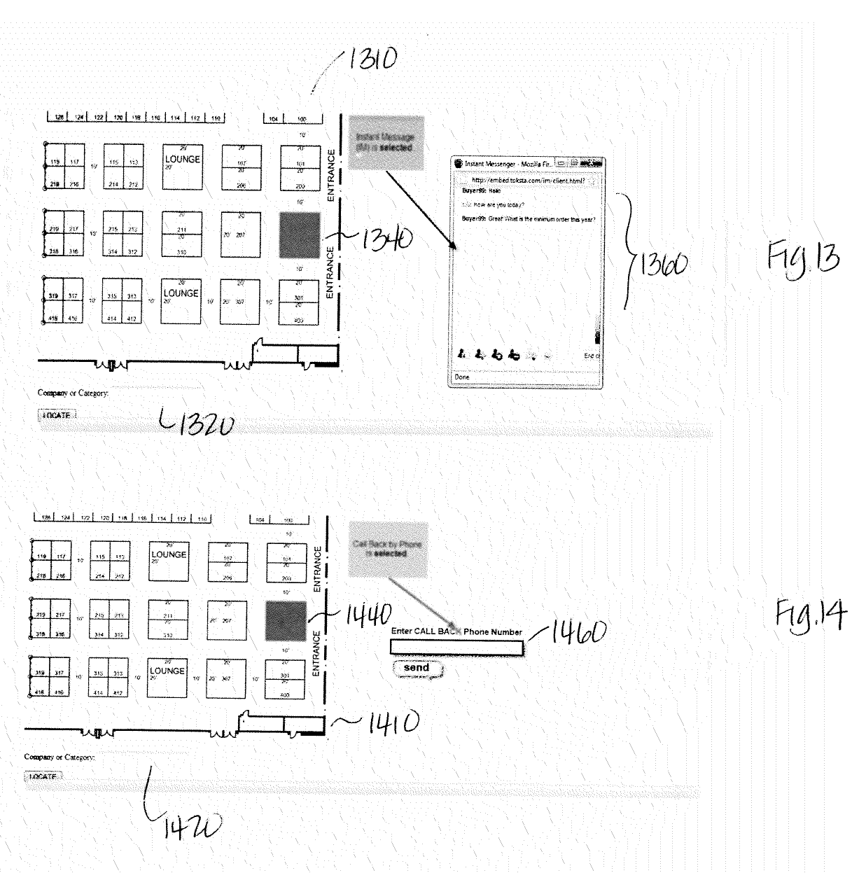

FIG. 1 shows a contemplated embodiment 100 showing a contemplated trade show floor map 110 comprising a “Company or Category” locate search box 120. The search box function will also allow the user to search by booth number, name or E-mail address, along with company name, product/service category or a combination thereof. The trade show floor map shows a plurality of booths that can be selected by the user.

FIG. 2 shows a contemplated embodiment 200 showing a contemplated trade show floor map 210 comprising a “Company or Category” locate search box 220 where the category “LCD” or “liquid crystal display” 230 is entered in the search box. FIG. 3 shows a contemplated embodiment 300 showing a contemplated trade show floor map 310 comprising a “Company or Category” locate search box 320 where the category “LCD” or “liquid crystal display” has been searched and the locations are highlighted 340.

FIG. 4 shows a contemplated embodiment 400 showing a contemplated trade show floor map 410 comprising a “Company or Category” locate search box 420 where the company “LG” 430 is entered in the search box. FIG. 5 shows a contemplated embodiment 500 comprising a contemplated trade show floor map 510 comprising a “Company or Category” locate search box 520 where company “LG” has been searched and the location is highlighted 540.

FIG. 6 shows a contemplated embodiment 600 showing a contemplated trade show floor map 610 where the company “LG” has been searched in a locate search box 620 and highlighted 640. In this embodiment, the user is viewing a product video 650 for LG and/or communicating directly and remotely with someone at LG or in the LG booth.

### Example 2

### Local Business on Map

FIG. 7 shows a contemplated road map 710 comprising a locate search box 720.

FIG. 8 shows a contemplated road map 810 comprising a locate search box 820 where company “99 Ranch Market” 830 has been entered in the locate search box.

FIG. 9 shows a contemplated road map 910 comprising a locate search box 920 where company “99 Ranch Market” 930 has been searched and the location is highlighted 940.

FIG. 10 shows a contemplated road map 1010 where the company “99 Ranch Market” 1030 has been searched in a locate search box 1020 and highlighted 1040. In this embodiment, the user is viewing a product video 1050 for 99 Ranch Market and/or communicating directly and remotely with someone at the market to get additional information.

### Example 3

### Trade Show Exhibition Floor with Interactive Communication

FIG. 11 shows a contemplated trade show floor map 1110 where the company “LG” has been searched in the locate search box 1120 and highlighted 1140. In this embodiment, the user (not shown) is communicating directly and remotely with someone at LG or in the LG booth using Wave text messaging 1160.

As discussed, the trade show floor map shows a plurality of booths that can be selected by the user. The physical booths are equipped with wave, video chat, instant messaging and E-mail, callback to phone functionality or a combination thereof. Wave is a form of communication that includes E-mails and threaded conversations, along with instant messaging, that allows users and booth employees to communicate in real-time when they are both online or in interactive mode.

FIG. 12 shows a contemplated trade show floor map 1210 where the company “LG” has been searched in the locate search box 1220 and highlighted 1240. In this embodiment, the user 1270 is communicating directly and remotely with someone at LG or in the LG booth using video communication methods 1260, such as Skype.

FIG. 13 shows a contemplated trade show floor map 1310 where the company “LG” has been searched in the locate search box 1320 and highlighted 1340. In this embodiment, the user (not shown) is communicating directly and remotely with someone at LG or in the LG booth using instant messaging 1360.

For all of these types of communication, it is contemplated that foreign languages and disability issues will be resolved by the system by providing translation services, third-party agents, closed captioning or other suitable services that allow communication to be understood by everyone in the communication loop.

FIG. 14 shows a contemplated trade show floor map 1410 where the company “LG” has been searched in the locate search box 1420 and highlighted 1440. In this embodiment, the user (not shown) is using the call back function 1460 which allows the user to provide a call back phone number or E-mail address where someone at the company or in the booth can contact the user when available.

Thus, specific embodiments, methods of information and communication systems, software and platforms, along with their methods of use have been disclosed. It should be apparent, however, to those skilled in the art that many more modifications besides those already described are possible without departing from the inventive concepts herein. The inventive subject matter, therefore, is not to be restricted except in the spirit of the disclosure herein. Moreover, in interpreting the specification and claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

I claim:

1. An information and communication system, comprising:
at least one virtual map comprising at least one contact,
at least one search box that is related to the at least one virtual map, and
at least one two-way interactive communication function.

2. The information and communication system of claim 1, wherein the at least one virtual map comprises a trade show booth layout, a job fair, a street map, a city map, a building layout, a mall layout or a combination thereof.

3. The information and communication system of claim 1, wherein the at least one contact comprises a vendor, a store, a professional services business, a manufacturing company, a potential employer or a combination thereof.

4. The information and communication system of claim 1, wherein the at least one two-way interactive communication function communicatively links at least one user with the at least one contact on the at least one virtual map.

5. The information and communication system of claim 1, wherein the at least one search box is a receptacle for contact identifier information.

6. The information and communication system of claim 5, wherein the contact identifier information comprises company name, company product category, company services category, contact name, contact electronic mail address or a combination thereof.

7. The information and communication system of claim 1, wherein the at least one two-way interactive communication function comprises wave messaging, text messaging, instant messaging or video communication functions.

8. The information and communication system of claim 4, wherein the communicative link comprises an internet network, an intranet network, a cloud network, a wireless network or a combination thereof.

9. The information and communication system of claim 1, wherein the at least one virtual map is available to a user before, during or after an event.

10. A method of using a two-way communication and information system comprises:
providing at least one prospective customer, customer, entity contact or a combination thereof,
providing at least one vendor contact,
providing at least one virtual map comprising the at least one vendor contact,
providing at least one search box that searchably relates the at least one vendor contact to the at least one virtual map,
utilizing the search box to locate a vendor contact of interest, and
utilizing at least one two-way interactive communication function to interactively connect the at least one vendor contact with the at least one prospective customer, customer, entity contact or a combination thereof in real-time.

11. The method of claim 10, wherein the at least one virtual map comprises a trade show booth layout, a job fair, a street map, a city map, a building layout, a mall layout or a combination thereof.

12. The method of claim 10, wherein the at least one contact comprises a vendor, a store, a professional services business, a manufacturing company, a potential employer or a combination thereof.

13. The method of claim 10, wherein the at least one two-way interactive communication function communicatively links at least one user with the at least one contact on the at least one virtual map.

14. The method of claim 10, wherein the at least one search box is a receptacle for contact identifier information.

15. The method of claim 14, wherein the contact identifier information comprises company name, company product category, company services category, contact name, contact electronic mail address or a combination thereof.

16. The method of claim 10, wherein the at least one two-way interactive communication function comprises wave messaging, text messaging, instant messaging or video communication functions.

17. The method of claim 13, wherein the communicative link comprises an Internet network, an intranet network, a cloud network, a wireless network or a combination thereof.

18. The method of claim 10, wherein the at least one virtual map is available to a user before or after an event.
